(19) United States
(12) Patent Application Publication
(10) Pub. No.: US 2015/0072116 A1
(43) Pub. Date: Mar. 12, 2015

(54) SIGN

(71) Applicants: Geoffrey Charles Wills, Mosgiel (NZ); Joanne Lilian Wills, Mosgiel (NZ)

(72) Inventors: Geoffrey Charles Wills, Mosgiel (NZ); Joanne Lilian Wills, Mosgiel (NZ)

(21) Appl. No.: 14/025,633

(22) Filed: Sep. 12, 2013

(51) Int. Cl. B32B 3/10

(52) U.S. Cl. CPC B32B 3/10
USPC 428/203

(57) ABSTRACT

A sign has an outer transparent layer, wherein the transparent layer is substantially formed from a UV resistant material. A substantially rigid or semi-rigid backing layer sufficient to enhance structural integrity of the sign is provided. An adhesive layer comprising a double sided adhesive sheet is between the transparent and backing layers, such adhesive layer serving to adhere the backing layer to at least one other part the sign. Imagery comprising artwork and/or writing between the transparent and adhesive layers, such imagery being viewable through the transparent layer is provided.

### FIELD OF INVENTION

This invention relates to a sign. A preferred form of the invention relates to a sign which resists damage by ultra violet (UV) light.

### BACKGROUND

Imagery on signs can fade due to UV damage from the sun. It is accordingly an object of a preferred form of the invention to go at least some way towards providing signs which are UV resistant, or to at least provide the public with a useful choice

### SUMMARY OF THE INVENTION

According to one aspect of the invention there is provided a sign having:
an outer transparent layer, wherein the transparent layer is substantially formed from a UV resistant material,
a substantially rigid or semi-rigid backing layer sufficient to enhance structural integrity of the sign,
an adhesive layer comprising a double sided adhesive sheet which is between the transparent and backing layers, such adhesive layer serving to adhere the backing layer to at least one other part the sign, and
imagery comprising artwork and/or writing between the transparent and adhesive layers, such imagery being viewable through the transparent layer.

Preferably the imagery is on a printed sheet between the transparent layer and the adhesive layer.

Preferably the printed sheet is adhered to the adhesive layer.

Preferably the imagery is reverse printed on an inner surface of the transparent layer.

Preferably the backing layer comprises an aluminium, alloy or plastic sheet.

Preferably the backing layer resists or blocks UV.

Preferably the transparent layer, the inner layer, and the backing layer are substantially formed from materials which contract and expand at a similar rate such that they do not delaminate from each other.

Preferably the outer layer comprises acrylic.

Preferably the adhesive layer is a self-adhesive sheet.

Preferably the adhesive layer is between approximately 0.1 mm and approximately 0.4 mm thick.

Preferably the transparent layer is between approximately 1 mm and approximately 4 mm thick.

Preferably the imagery is formed from ink approximately 0.01 mm thick.

### BRIEF DESCRIPTION OF DRAWINGS

Some preferred embodiments of the invention will now be described by way of example and with reference to the accompanying drawing, of which:

FIG. 1 is an exploded view illustrating components of the sign.

### DETAILED DESCRIPTION

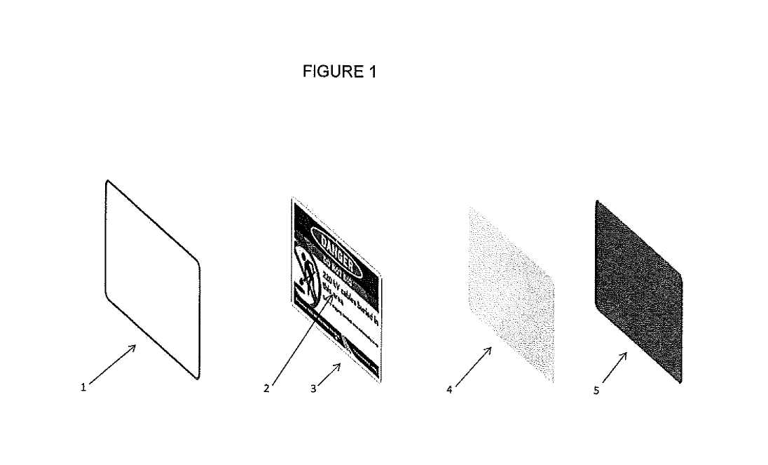

Referring to FIG. 1, the sign has an outer transparent layer substantially formed from a UV resistant material 1. This UV resistant material may be acrylic and is typically between 2-3 mm thick.

As shown in FIG. 1, imagery 2 comprising artwork and/or writing is between the transparent layer 1 and an inner adhesive layer 4. The imagery can be printed on a sheet 3 located between the transparent layer 1 and the adhesive layer 4. The printed sheet 3 is adhered to the transparent layer 1. In some embodiments of the invention the imagery can be reverse printed on an inner surface of the transparent layer 1 (not shown), and in that case the printed sheet 3 would be absent. The imagery is viewable through the transparent layer 1. The imagery may comprise ink of approximately 0.01 mm thick.

The adhesive layer 4 comprises a double sided adhesive sheet which on one side is adhered to the backing layer 5. The other side of the adhesive layer 4 is adhered to sheet 3, or directly to the printed transparent layer 1 in cases where the sheet 3 is omitted. The adhesive layer 4 can be a self-adhesive sheet, typically between 0.1 mm and 0.4 mm thick.

As indicated in FIG. 1, the backing layer 5 is located at the back of the sign. The backing layer 5 is substantially rigid or semi-rigid and is sufficient to enhance the structural integrity of the sign. The backing layer 5 may be made from aluminium, alloy or plastic sheet. The backing layer 5 can be made from UV resistant material.

The components of the sign are preferably made from materials which contract and expand at a similar rate at ambient temperature such that they do not delaminate from each other.

While some preferred embodiments of the invention have been described by way of example it should be appreciated that modifications and improvements can occur without departing from the scope of the following claims.

1. A sign having:
an outer transparent layer, wherein the transparent layer is substantially formed from a UV resistant material,
a substantially rigid or semi-rigid backing layer sufficient to enhance structural integrity of the sign,
an adhesive layer comprising a double sided adhesive sheet which is between the transparent and backing layers, such adhesive layer serving to adhere the backing layer to at least one other part the sign, and
imagery comprising artwork and/or writing between the transparent and adhesive layers, such imagery being viewable through the transparent layer.

2. A sign according to claim 1, wherein the imagery is on a printed sheet between the transparent layer and the adhesive layer.

3. A sign according to claim 2, wherein the printed sheet is adhered to the adhesive layer.

4. A sign according to claim 1, wherein the imagery is reverse printed on an inner surface of the transparent layer.

5. A sign according to claim 1, wherein the backing layer comprises at least one of aluminium, alloy or plastic sheet.

6. A sign according to claim 1, wherein the backing layer resists or blocks W.

7. A sign according to claim 1, wherein the transparent layer, the inner layer, and the backing layer are substantially formed from materials which contract and expand at a similar rate such that they do not delaminate from each other.

8. A sign according to claim 7, wherein the outer layer comprises acrylic.

9. A sign according to claim 1, wherein the adhesive layer is a self-adhesive sheet.

10. A sign according to claim 1, wherein the adhesive layer is between approximately 0.1 mm and approximately 0.4 mm thick.

11. A sign according to claim 1, wherein the transparent layer is between approximately 1 mm and approximately 4 mm thick.

12. A sign according to claim 1, wherein the imagery is formed from ink approximately 0.01 mm thick.

13. A sign having:
an outer transparent layer, wherein the transparent layer is substantially formed from a UV resistant material,
a substantially rigid or semi-rigid backing layer sufficient to enhance structural integrity of the sign, wherein the backing layer resists or blocks UV.
an adhesive layer comprising a double sided adhesive sheet which is between the transparent and backing layers, such adhesive layer serving to adhere the backing layer to at least one other part the sign;
imagery comprising artwork and/or writing between the transparent and adhesive layers, such imagery being viewable through the transparent layer; and
wherein the transparent layer, the inner layer, and the backing layer are substantially formed from materials which contract and expand at a similar rate such that they do not delaminate from each other.

14. A sign according to claim 1, substantially as herein described.

15. A sign substantially as herein described with reference to the accompanying drawings.
